(19) United States
(12) Patent Application Publication
(10) Pub. No.: US 2009/0086961 A1
(43) Pub. Date: Apr. 2, 2009

(54) MONTGOMERY MASKED MODULAR MULTIPLICATION PROCESS AND ASSOCIATED DEVICE

(75) Inventors: Alain SAUZET, Bondoufle (FR); Florent Bernard, Monistrol Sur Loire (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/134,259

(22) Filed: Jun. 6, 2008

(30) Foreign Application Priority Data
Jun. 7, 2007 (FR) 0704086

(51) Int. Cl. H04L 9/28

(52) U.S. Cl. 380/28

(57) ABSTRACT

This invention concerns a Montgomery masked modular multiplication process and the associated device. The modular multiplication, in congruence n, includes at least a stage generating a pseudo-random number z and a stage adding to the result the product of the said number by n. The invention applies in particular to the securing of processors dedicated to cryptographic calculations.

### RELATED APPLICATIONS

The present application is based on, and claims priority from, French Application Number 07 04087, filed Jun. 7, 2007, the disclosure of which is hereby incorporated by reference herein in its entirety.

### FIELD OF THE INVENTION

This invention concerns a Montgomery masked modular multiplication process and the associated device. It applies in particular to the security protection of processors dedicated to cryptographic calculations.

### BACKGROUND OF THE INVENTION

One of the purposes of cryptography is to encrypt sensitive data using a secret element, which is generally a cryptographic key. The key value must necessarily be protected to prevent the disclosure of sensitive data. The cryptographic algorithms are designed to ensure that in practice the key cannot be found. In theory, finding the key calls for calculation resources usually beyond the scope of a government and a calculation time going beyond the human scale. Some attackers have, however, found a way round these mathematical difficulties by using physical measurements to find the key value. One method used is thus the auxiliary channel attack. This involves measuring the behaviour of a cryptographic calculation block during the use of the key. Indeed, some operations are performed according to the key value. But physical magnitudes vary according to the operations performed by the calculation block and the data involved in these operations. For example, measuring the electrical consumption of a circuit, the calculation time or the electromagnetic radiation produced by a component allows the identification of certain operations performed or certain data processed. The value of the key used may thus be found by analyzing these measurements.

To protect security systems making use of asymmetric cryptography processes, this type of attack should be made at least as difficult to perform as conventional cryptographic attacks. Known solutions allow the effectiveness of these attacks to be reduced, but not, however, prevented. These solutions may involve changing the calculation algorithm and/or the data handled to ensure that the measurements of physical magnitudes reveal the least possible information about the operations performed by the calculation block. Several categories of protection methods have been established.

One category involves the adding of phantom calculation blocks. Although these specific blocks are not involved in the calculation, they change the electrical consumption and/or the electromagnetic radiation. This type of countermeasures is not completely effective as measurement processing allows the influence of these phantom calculation blocks to be eliminated and thus ignored.

Another category of protection methods prevents the algorithm execution being dependent on the key value. This method is necessary but not sufficient.

A third category introduces a random disruption of data. This protection method is generally qualified as “masking”. This involves manipulating data which are normally not connected with unencrypted or encrypted data with a view to reducing the correlation between the measurements and the known data.

The implementation of these protection methods is inevitably accompanied by a few drawbacks. On the one hand, it increases the calculation time and/or the code size for software implementations, or the surface of circuits for hardware implementations. On the other, cryptographic algorithms are generally implemented in a calculation system by layers. Elementary calculation blocks are used by higher level algorithms, which are themselves used to implement cryptographic algorithms. Changing an elementary block may thus cause unexpected, or even incorrect, behaviour, in some higher level algorithms using this changed elementary block. To avoid these errors, some changes are sometimes necessary at the level of the algorithms and/or the calculation system architecture. The integration of a changed elementary block is thus made complex, due to the many effects on the higher algorithm layers.

By way of example, use is often made of multiplication masking as it seems natural in terms of asymmetric cryptography. Calculations are normally performed in a modular ring of congruence n. Multiplication masking is implemented, during the execution of an algorithm, by the manipulation of a number x′ equal to ((x·r) modulo n) instead of manipulating the (x modulo n), where r is an uncertainty n the modulus. However, multiplication masking has several drawbacks. On the one hand, it calls for an additional division to obtain the expected result. And such a division operation is costly in terms of calculation time and hardware resources. On the other, the uncertainty r is defined throughout the running of the algorithm, and this may prove to be a loophole which can be used by an attacker. In addition, when an algorithm uses certain elliptic curves, other vulnerabilities may emerge with multiplication masking, in particular when an attacker chooses a point with zero coordinates on the said curve.

Another known masking method is the running of algorithms in a modular ring of congruence k.n, where k is a natural integer. However, increasing the size of the module used for calculations calls for a resealing of the software and/or hardware resources implemented.

Another masking process was disclosed in a European patent request published under the number EP1239364. This is a technique involving two multiplications one of which is masked. This solution, in the same way as the previous ones, is not easy to include in an existing multilayer calculation system. Indeed, it notably calls for changes in the algorithms used by the cryptographic functions.

One of the basic operations used by asymmetric encryption algorithms is modular multiplication. This operation allowing the calculation of a modulo n product of two integers, is used by a large number of algorithms. It should thus include protection against attacks by auxiliary channels.

A further requirement to be met is the solution flexibility, in other words, its ability to process numbers of varying sizes.

### SUMMARY OF THE INVENTION

One of the aims of the invention is to protect the modular multiplication operation by a method calling for very little extra calculation time overhead, requiring very little additional hardware resources, and having no effect on higher level algorithms. For this purpose, the aim of the invention is to provide a Montgomery modular multiplication process with a congruence n executed by a cryptographic component, with the process receiving two input operands A+k₁.n and B+k₂.n, A and B being less than n, k₁ and k₂ being integers, the process comprising at least the following stages:
calculate an intermediate result S equal to A.B mod n;
generate a pseudo-random number z;
add the product of the said number z multiplied by n to the intermediate result S.
   The process in the present invention could include at least the following stages:
S←x₀.y
for i ranging from 0 to tₙ−1, do:
   mᵢ←S₀.n′ mod r
   S←xᵢ.y+(mᵢ.n+S)/r
mₜₙ←S₀.n′ mod r
determine a pseudo-random number z
S←z.n+(mₜₙ.n+S)/r

where r designates the numbering base, tₙ the size of the module n in number of machine-words, x and y the operands to be multiplied, mᵢ intermediate coefficients, S the multiplication result, and value n′ being equal to −n⁻¹ mod r.

According to an implementation method, the modular multiplication is performed in a high numbering base of not less than 4.

According to an implementation method, the pseudo-random number z is calculated in accordance with the multiplication input operands x=A+k₁.n and y =B+k₂.n.

According to an implementation method in which the number x is formed by the machine-words x₀ x₁ . . . Xₜₙ and the number y is formed by the machine-words y₀ y₁ . . . yₜₙ, the pseudo-random word z is equal to x₀ xor x₁ xor . . . xor Xₜₙ xor y₀ xor Y₁ xor . . . xor Yₜₙ, xor designating the binary “exclusive or” operation.

The aim of the invention is also to provide a device for implementing Montgomery modular multiplication including at least a calculation cell containing a multiplier-adder comprising p pipelined logic-register pairs, receiving several digits to be added and multiplied, at least two outputs corresponding to the low order and high order, an adder receiving the two outputs of the multiplier-adder, the device including an additional b−1 bits+1 bit to b bits adder.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

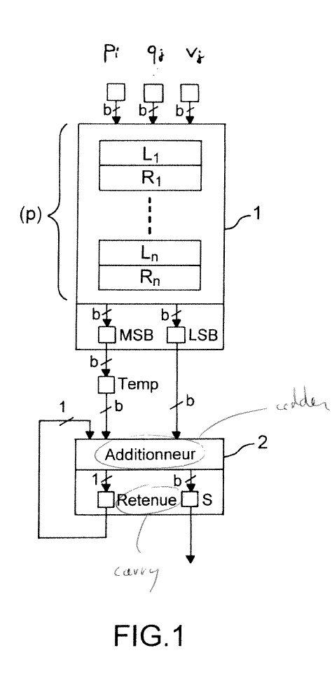

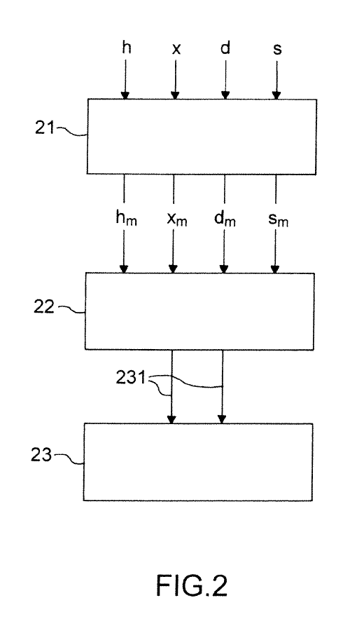

The present invention is illustrated by way of example, and not by limitation, in the figures of the accompanying drawings, wherein elements having the same reference numeral designations represent like elements throughout and wherein:
in FIG. 1, an example of the multiplication-addition cell used in masked modular multiplication in the present invention,
in FIG. 2, a schematic diagram of the use of a multiplier implementing the masking process in the present invention by an algorithm making use of the modular multiplication operation.

### DETAILED DESCRIPTION OF THE INVENTION

The multiplier in the present invention is hardware implemented on an ASIC (Application-Specific Integrated Circuit) or FPGA (Field-Programmable Gate Array) and operates on a b-bit data bus.

A number of bits b is qualified hereafter by the term “machine word”. The bus size is often a power of 2. The numbering base r is defined as being equal to 2^{b}. The modulus is an odd number saved as tₙ machine words. And finally, R is defined as a power of the numbering base, where R is greater than the modulus n. A number x can be broken down in the base r as t+1 digits xᵢ as follows:

x=x₀+x₁.r+x₂.r²+ . . . +xₜ.r^{t},

where each digit xᵢ is the size of a machine word.

The multiplier in the present invention uses two numbers x and y to calculate x.y.R⁻¹ mod n+e.n, where e is a value dependent on x and y, and between 0 and r/2. The operation x.y.R⁻¹ mod n is the Montgomery modular multiplication. The multiplier thus performs a Montgomery modular multiplication and an additive masking of the result of this multiplication. As the value e depends on x and y, when the input values x and y are already masked by a random value before being used by the multiplier, the result is itself also masked by a random value. The multiplier thus propagates the masking of the input data.

According to an implementation variant, the value e depends on a random variable independent of x and y.

Before performing multiplications, a value, designated n′, is precalculated: n′=−n⁻¹ mod r. The multiplication result is designated S. The digits of a number N in the base r are designated Nᵢ.

The Montgomery modular multiplication with additive masking of the result is calculated through the following process:
i. S←x₀.y
ii. for i ranging from 0 to tₙ−1, do:
   a. m_{i←s}₀.n′ mod r
   b. S←xᵢ.y+(mᵢ.n+S)/r
iii. mₜₙ←S₀.n′ mod r
iv. z←x₀ xor x₁ xor . . . xor Xₜₙ xor y₀ xor y₁ xor . . . xor Yₜₙ
v. S←z.n+(mₜₙ.n+S)/r
   where the values mᵢ are the intermediate coefficients of the calculation.

The role of the fourth stage (iv) is to provide a pseudo-random value z dependent on x and y. The process for calculating this pseudo-random value z given in the above example may be changed to combine the numbers x and y differently. The fifth stage (v) includes the uncertainty generated during the previous stage, in the multiplication result. As the number added (z.n) is a multiple of n, the modified result is congruous with the result as it would have been generated by a conventional process.

The stage (ii. b.) (S←xᵢ.y+(mᵢ.n+S)/r) is the most costly in terms of calculation time. It can be performed by a sequence of two multiplication-addition operations,
the first multiplication-addition being S ←(mᵢ.n+S)/r,
and the second multiplication-addition being S←xᵢ.y+S.
   Each multiplication-addition is performed by a loop, and the first multiplication-addition differs from the second by a division by r.

According to an implementation method, the loop performed by the second multiplication-addition is as follows:
c=0
For j ranging from 0 to tₙ, do:
   P ←pᵢqⱼ+vⱼ+c
   s_{j←LSB(P)}
   c←MSB(P)
Sₙ₊₁=C
   where s designates the multiplication-addition result pᵢ.q+v, and c is a carry variable.

During the modular multiplication stage (ii. b.), the value pᵢ is replaced by Xᵢ, the value q is replaced by y and the value v is replaced by S. The basic operation P←pᵢqⱼ+vⱼ+c is performed with pᵢ, qⱼ, vⱼ, where c ranges from 0 to r−1. The intermediate result P is thus between 0 and r²−1, and is expressed as two digits. The expression LSB(P) designates the low order digit, and MSB(P) the high order digit of the number P.

Unlike a multiplication-addition operating on unmasked numbers, where qₙ is equal to 1 or less, the multiplication-addition implemented by the device in the present invention performs an operation on a digitn of between 0 and r/2 in the last iteration of the loop (when j=tₙ),. The value Sₙ₊₁ can thus be greater than 2.

The first multiplication-addition S←(mᵢ.n+S)/r is performed similarly to the second multiplication-addition but also shifts the result by b bits towards the lower order bit. This shift is equivalent to a division by r. The multiplication-addition with a shift is performed as follows:
c=0
For j ranging from 0 to tₙ, do:
   P←pᵢqⱼ+vⱼ+c
   sⱼ₋₁←LSB(P)
   c←MSB(P)
Sₙ=C+Vₙ₊₁

During the modular multiplication stage (ii. b.), the value pᵢ is replaced by mᵢ, the value q is replaced by n and the value v is replaced by S. Thus, for the iteration j=tₙ, nⱼ=0 by definition of tₙ, and thus P≦2(r−1), implying MSB(P)≦1.

The loop is thus, give or take an index shift, close to the loop corresponding to the second multiplication-addition, allowing the implementing of a component able to perform two loops to be considered. A multiplier can notably break the operation pᵢqⱼ+vⱼ+c down into (pᵢqⱼ+vⱼ)+c, by pipelining the multiplication-addition operation (pᵢqⱼ+vⱼ) and adding the variable c as the results are obtained.

FIG. 1 is an example of the multiplication-addition cell used in the masked modular multiplication in the present invention. The cell calculates the two multiplication-addition operations described above. It is pipelined to improve its performance. The pipeline involves adding register barriers between the logic phases to reduce the critical path, and thus increase the maximum operating frequency (theoretically that of a base r adder).

The pipeline depth of an elementary component is defined by its number of internal registers. The output register is not counted.

The example given in FIG. 1 assumes the availability of a pipelined multiplier-adder 1, of depth p.

It notably includes a set of logic-register pairs (Ii, ri). The number p of these pairs is notably chosen to ensure that the maximum frequency F1 max of the pipelined multiplier-adder is not less than the adder's maximum frequency F2max, the values of these two frequencies being as similar as possible.

The maximum operating frequency of the multiplier-adder is given by the inverse of the run time of the multiplication-addition operation, whereas the maximum operating frequency of the pipelined multiplier-adder is given by the inverse of the execution time of only one of the p stages. For optimum operation, the adder's maximum frequency is determined, which gives the adder's run time and the multiplier-adder is broken down into p stages with a throughput time not exceeding, but as close as possible to, the adder's run time.

The inputs of the multiplier-adder 1 correspond to three digits: pᵢ, qⱼ and vⱼ and the output is a pair of digits corresponding to LSB(pᵢqⱼ+vⱼ) and MSB(pᵢqⱼ+vⱼ). The output is two digits long.

The multiplier-adder results are sent to a three-input adder, referenced 2: digit+digit+carry←digit+carry, operating over 1 cycle (pipeline 0) at a frequency of F2max.

The register Temp corresponds to the storing of c required for the following calculation: add c to the next LSB and the previous carry.

The data (digits of p×Q+V) are thus output in series at each cycle, with the low order digit first, in the same direction as the carry propagation.

The operation sₙ=c+vₙ₊₁ can be performed by an adder, not shown in the figure, using b−1 bits +1 bit=b bits and not 2 bits+1 bits=3 bits, as in a conventional device, since vₙ₊₁ may be greater than 2.

The other stages in the Montgomery modular multiplication process with additive masking of the result can be implemented using conventional registers and multiplexers. A multiplier performing a modular multiplication as per the Montgomery method is described in the patent request published under the number WO2006103288.

The stages in the masking process in the present invention can be readily implemented in a device including a multiplication-addition cell as described above. The pseudo-random number can be generated by a logic component with two inputs and one output, with the first input receiving the first operand x to be multiplied, the second input receiving the second operand y to be multiplied, and the output producing a combination of x and y, such as a number equal to x xor y, for example, where xor designates the binary exclusive OR operation. The pseudo-random number z obtained from this logic component can then be combined with n in a multiplier to provide a multiple pseudo-random of n, equal to z.n.

FIG. 2 is a schematic diagram of the use of a multiplier implementing the masking process in the present invention by an algorithm making use of the modular multiplication operation. During the algorithm execution, all the multiplications performed operate on numbers, all obtained from a few fixed initial values. By way of example, four initial values designated h, x, d and s are used to generate all the other values used in the algorithms.

In an initial first stage 21, an additive masking is implemented on these initial values h, x, d and s. The masked values hₘ, xₘ, dₘ, and sₘ are obtained as follows:

hm=h+eₕ.n; xₘ=eₓ.n; dₘ=e_{d}.n; sₘ=eₛ.n; where eₕ, eₓ, e_{d}, eₛ, are random values between 0 and 2^{p}. In practice, the value p should preferably at least be equal to 63 for the additive masking to be effective.

In a second stage 22, the algorithm is executed by making use of the multiplier in the present invention, as many times as necessary. No change to the algorithm is required, and all the results produced by the multiplier in the present invention are masked, allowing the algorithm to process the masked data only.

After the algorithm is executed, a “unmasking” operation is applied, in a third stage 23, to the masked values 231 to find the results which would have been obtained without masking. This operation can, for example, be implemented by the multiplier in the present invention by choosing specific input values.

The use of the device illustrated in FIG. 2 shows that the values used in the calculations are uncorrelated from the initial values. As a consequence, an attacker analyzing physical magnitudes during the algorithm execution can thus no longer, through a judicious choice of input variables, locate the secret data used during the calculation. In a conventional device, for example, an attacker can choose an input variable including a large number of ‘0’ or a large number of ‘1’, and then analyze the electrical consumption to determine a relationship between the input variables and the consumption and/or deduce the type of operations performed by the algorithm. Through the use of additive masking, these long initial sequences of ‘0’ or ‘1’ are eliminated in the operands used by the algorithm, thus reducing any assumptions that the attacker may have been able to make as regards any input variables selected by the attacker himself.

The extra overhead in terms of calculation time and, in the case of a hardware integration, circuit surface area, is very low.

The multiplier block advantageously allows algorithms to be executed on numbers of any size without changing the hardware implementation. A multiplier synthesized in FPGA or ASIC and implemented in the present invention performs multiplications on any modules 128, 256, 512, 1024, and 2048 bits in size, for example.

One of the advantages of the process in the present invention is that it can be implemented in a cryptographic calculation component existing transparently as far as the component architecture is concerned. Indeed, the conventional modular multiplication calculation operator only has to be replaced by an operator implementing the process in the present invention. The replacement of this elementary operation then globally improves the component protection, since the functions used by security mechanisms such as encryption or authentication make use of the operator in the present invention.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Montgomery modular multiplication process with a congruence n executed by a cryptographic component, with the process receiving two input operands A+k₁.n and B+k₂.n, A and B being less than n, k₁ and k₂ being integers, the process comprising the following stages:
calculate an intermediate result S equal to A.B mod n;
generate a pseudo-random number z;
add, to the intermediate result S, the product of the said number z multiplied by n.

2. The process according to claim 1, wherein it comprises the following stages:
S←x₀.y
for i ranging from 0 to tₙ−1, do:
mᵢ←S₀.n′ mod r
S←xᵢ.y+(mᵢ.n+S)/r
mₜₙ←S₀.n′ mod r
determine a pseudo-random number z
S←z.n+(mₜₙ.n+S)/r
where r designates the numbering base, tₙ the size of the module n in number of machine-words, x and y the operands to be multiplied, mᵢ intermediate coefficients, S the multiplication result, and value n′ being equal to −n⁻¹ mod r.

3. The process according to claim 2, wherein the modular multiplication is performed in a high numbering base of not less than 4.

4. The process according to claim 1, wherein the pseudo-random number z is calculated according to the multiplication input operands x=A+k₁.n and y=B+k₂.n.

5. The process according to claim 4, the number x being formed by the machine-words x₀ x₁ . . . xₜₙ, and the number y is formed by the machine-words y₀ y₁ . . . yₜₙ, wherein the pseudo-random word z is equal to x₀ xor x₁ xor . . . xor xₜₙ xor y₀ xor y₁ xor . . .xor yₜₙ.

6. Montgomery modular multiplication implementation device including at least a calculation cell containing a multiplier-adder comprising p pipelined logic-register pairs, receiving several digits to be added and multiplied, at least two outputs corresponding to the low order and high order, an adder receiving the two outputs of the multiplier-adder, the device being characterised in that it includes an additional b−1 bits+1 bit to b bits adder.

7. The process according to claim 2, wherein the pseudo-random number z is calculated according to the multiplication input operands x=A+k₁.n and y=B+k₂.n.
